(19) United States
(12) Patent Application Publication
(10) Pub. No.: US 2013/0246284 A1
(43) Pub. Date: Sep. 19, 2013

(54) Property-Space Similarity Modeling

(71) Applicant: THE PROCTER & GAMBLE COMPANY, Cincinnati, OH (US)

(72) Inventor: David Thomas Stanton, Hamilton, OH (US)

(73) Assignee: The Procter & Gamble Company, Cincinnati, OH (US)

(21) Appl. No.: 13/890,314

(22) Filed: May 9, 2013

Related U.S. Application Data
(63) Continuation of application No. 13/334,180, filed on Dec. 22, 2011.

(30) Foreign Application Priority Data
Jul. 7, 2009 (WO) 2009052956

(51) Int. Cl. G06Q 10/10

(52) U.S. Cl. CPC G06Q 10/101
USPC 705/300

(57) ABSTRACT

The present invention relates to modeling systems for designing consumer products and selected components for use in consumer products, consumer products and components selected by such models and the use of same. In addition, a system that minimizes the risks associated with a collaboration yet promotes the rapid advance of the subject/goal of the collaboration is disclosed.

### FIELD OF THE INVENTION

The present invention relates to modeling systems for designing consumer products and selected components for use in consumer products and components selected by such models and the use of same.

### BACKGROUND OF THE INVENTION

Consumer goods are typically designed and/or formulated using empirical methods or basic modeling methodologies. Such efforts are time consuming, expensive and, in the case of empirical methodologies, generally do not result in optimum designs/formulations as not all components and parameters can be considered. Furthermore, aspects of such methods may be limited to existing components. Thus, there is a need for an effective and efficient methodology that obviates the short comings of such methods. New modeling processes have been disclosed, (See for example USPA 2008/0040082 A1). Such processes are an improvement, yet further improvements are desired as the performance of many consumer products and the components thereof is the function of multiple simultaneous properties. Thus there is a need for improvements that allow for efficient multidimensional modeling systems. The modeling systems of the present invention meet the aforementioned need and, in addition, can be used to select or design new and superior formulation component that can be used to produce new and superior formulations.

In addition, many modeling efforts require collaboration, for example, the collaboration of a raw material supplier and a formulator. In many cases, such collaboration requires the exchange of confidential information. As receiving and supplying confidential entails risk for both the receiving party and the supplying party—particularly when one or more of the parties has multiple collaborations going simultaneously—the parties typically desire to minimize the confidential information that is exchanged. This desire typically conflicts with the parties need to rapidly advance the subject/goal of the collaboration. Thus, what is needed is a system that minimizes the risks associated with a collaboration yet promotes the rapid advance of the subject/goal of the collaboration. Such a system is disclosed herein.

### SUMMARY OF THE INVENTION

The present invention relates to modeling systems for designing consumer products and selected components for use in consumer products, consumer products and components selected by such models and the use of same. In addition, a system that minimizes the risks associated with a collaboration yet promotes the rapid advance of the subject/goal of the collaboration is disclosed.

### DETAILED DESCRIPTION OF THE INVENTION

### Definitions

As used herein “consumer products” includes, unless otherwise indicated, articles, baby care, beauty care, fabric & home care, family care, feminine care, health care, snack and/or beverage products or devices intended to be used or consumed in the form in which it is sold, and is not intended for subsequent commercial manufacture or modification. Such products include but are not limited to home décor, batteries, diapers, bibs, wipes; products for and/or methods relating to treating hair (human, dog, and/or cat), including bleaching, coloring, dyeing, conditioning, shampooing, styling; deodorants and antiperspirants; personal cleansing; cosmetics; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, pet health and nutrition, and water purification; processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); and coffee and cleaning and/or treatment compositions

As used herein, the term “cleaning and/or treatment composition” includes, unless otherwise indicated, tablet, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein the term “non-polymer consumer product component” does not include polymers.

As used herein, the term “situs” includes paper products, fabrics, garments and hard surfaces.

As used herein, the articles “a”, “an”, and “the” when used in a claim, are understood to mean one or more of what is claimed or described.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Modeling Methods

A process, of selecting a consumer product component for use in a consumer product, that may comprise:
a) comparing two or more independent properties of an actual or hypothetical initial consumer product component with the same independent properties of one or more actual or hypothetical additional consumer product components;
b) selecting those one or more actual or hypothetical additional consumer product components in the proximity of said suitable actual or hypothetical initial consumer product component when said two or more independent properties of said actual or hypothetical initial consumer product component and said actual or hypothetical additional consumer product components are mapped via calculation or graphically in a multi-dimensional space having the same dimensions as the number of said independent properties;
c) sorting the list of actual or hypothetical additional consumer product components in order of increasing distance and selecting for consideration those materials with shortest distance to the initial actual or hypothetical initial consumer product component;
d) optionally, using the output of Step b.) to refine the selection of a new actual or hypothetical initial consumer product component by repeating Steps a) through b)
e) optionally repeating Steps a) through c)
   is disclosed.

In one aspect of the aforementioned process, said two or more independent properties may be selected from the group consisting of Amine-assisted perfume delivery, Western-European washing conditions, 5-weeks post-dry storage model (WE-5); Amine-assisted perfume delivery, North-American washing conditions, 1-week post-dry storage model (NA-1) model; Polymer amine-assisted perfume delivery, Western-European washing conditions, 1-day post-dry storage model (WE-1) model; vapor pressure; boiling point; betaCyclodextrins complex stability constant; malodor reduction value; SDS micelle-water partition coefficient; Henrys Law (air-water partition) coefficient; odor character; critical micelle concentration; dynamic surface tension; grease/oil stain removal; grass stain removal; clay/soil stain removal; biodegradability; chemical reactivity; odor masking; Kovats index; packaging compatibility; LogP; ammonia odor reduction; flash point; aqueous solubility; perfume ingredient color/odor stability decision model; liquid dish product-air perfume raw material partition coefficient; shampoo product-air perfume raw material partition coefficient; hair conditioner product-air perfume raw material partition coefficient; and intrinsic aqueous solubility.

In one aspect of the aforementioned process, said proximity, d(x,y), may be determined by a method selected from computing a distance or dissimilarity coefficient using the following equation:

$$d ( x , y ) = {[ {\sum }_{i = 1}^{m} \vert {x}_{i} - {y}_{i} {\vert}^{r} ]}^{1 \text{/} r}$$

where x=(x₁, x₂, . . . , xₘ) and y=(y₁, y₂, . . . yₘ) represent two points in the m-dimensional space and wherein in the case of the distance measure for the city-block metric r=1, and wherein in the case of the distance measure for the Euclidean distance metric r=2.

In one aspect of the aforementioned process, said proximity may be determined by computing the Euclidean distance metric.

In one aspect of the aforementioned process, the consumer product component that is selected may be selected from the group consisting of a perfume, a surfactant, or a solvent.

In one aspect of the aforementioned process,
a) said perfume may be selected for use in an Amine-Assisted Perfume Delivery System, Polymer amine-assisted perfume delivery, betaCyclodextrins delivery system, a shampoo, an aircare product, a hair dye, a color and odor stable deodorant product, a liquid dish product, a candle or a microcapsule;
b) said surfactant may be selected for use in a laundry cleaning product; and
c) said solvent may be selected for use in a heavy duty liquid laundry detergent.

In one aspect of the aforementioned process, the values for said independent properties may be calculated, measured or obtained from a reference source.

In one aspect of the aforementioned process, said perfume may be selected for use in an Amine-Assisted Perfume Delivery System and said one or more independent properties may comprise;
a.) NA-1 model; vapor pressure and octanol-water partition coefficient; and, optionally, boiling point; or
b.) WE-5 model; vapor pressure and octanol-water partition coefficient; and, optionally, boiling point.

In one aspect of the aforementioned process, said perfume may be selected for use in a Polymer amine-assisted Perfume Delivery System and said one or more independent properties may comprise; WE-1 model; vapor pressure, and octanol-water partition coefficient; and, optionally, boiling point.

In one aspect of the aforementioned process, said perfume may be selected for use in a betaCyclodextrins delivery system and said one or more independent properties may comprise betaCyclodextrin complex stability constants; and vapor pressure; and, optionally, malodor reduction value.

In one aspect of the aforementioned process, said perfume may be selected for use in a shampoo and said one or more independent properties may comprise SDS micelle-water partition coefficient; Henrys Law (air-water partition) coefficient; and vapor pressure; and, optionally, odor character.

In one aspect of the aforementioned process, said perfume may be selected for use in a hair dye and said one or more independent properties may comprise the octanol-water partition coefficient; chemical reactivity; vapor pressure; and ammonia odor reduction.

In one aspect of the aforementioned process, said surfactant may be selected for use in a laundry cleaning product and said one or more independent properties may comprise critical micelle concentration; dynamic surface tension; grease/oil stain removal; grass stain removal; clay/soil stain removal; and biodegradability.

In one aspect of the aforementioned process, said perfume may be selected for use in a color and odor stable deodorant product and said one or more independent properties may comprise the perfume ingredient color/odor stability decision model, LogP, vapor pressure and odor masking.

In one aspect of the aforementioned process, said perfume may be selected for use in a liquid dish product and said one or more independent properties may comprise the liquid dish product-air perfume raw material partition coefficient, Henrys Law (air-water partition) coefficient, LogP and vapor pressure.

In one aspect of the aforementioned process, said perfume may be selected for use in a candle and said one or more independent properties may comprise Kovats index, LogP, and, optionally, odor masking.

In one aspect of the aforementioned process, at least one independent property may be determined by employing a technique selected from the group consisting of multiple linear regression, genetic function method, generalized simulated annealing, principal components regression, non-linear regression, projection to latent structures regression, neural networks, support vector machines, logistic regression, ridge regression, cluster analysis, discriminant analysis, decision trees, nearest-neighbor classifier, molecular similarity analysis, molecular diversity analysis, comparative molecular field analysis, Free and Wilson analysis, group contribution methods and combinations thereof.

In one aspect of the aforementioned process, said technique may be selected from the group consisting of multiple linear regression, genetic function method, generalized simulated annealing, principal components regression, non-linear regression, projection to latent structures regression, neural networks, support vector machines, logistic regression, ridge regression, cluster analysis, discriminant analysis, molecular similarity analysis, molecular diversity analysis, group contribution methods and combinations thereof.

In one aspect of the aforementioned process, said technique may be selected from the group consisting of multiple linear regression, genetic function method, generalized simulated annealing, projection to latent structures regression, neural networks, cluster analysis, discriminant analysis, molecular similarity analysis, molecular diversity analysis, group contribution methods and combinations thereof.

In one aspect of the aforementioned process, said consumer product component may be selected from the group consisting of surfactants, chelating agents, dye transfer inhibiting agents, dispersants, and enzyme stabilizers, catalysts, bleach activators, sources of hydrogen peroxide, preformed peracids, brighteners, dyes, perfumes, carriers, hydrotropes, solvents and combinations thereof.

In one aspect of the aforementioned process, Steps a.) through c.) are repeated at least once.

In one aspect, any or all of the computations of the processes disclosed herein may be preformed by a computing device. Such computing device may be a portable device, for example, a laptop computer.

In one aspect, computing the distance in the multi-dimensional property space may be performed by entering the distance equation, for example, the Euclidean distance equation, into a spreadsheet program, for example, Excel® 2007 (MicroSoft, Redmond, Wash. 98052-7329) that is run on a computer.

### Method of Obtaining Independent Properties

The independent properties used in the present modelling system may be obtained by any of the means, including combinations there of, described below

In one aspect, the independent properties used in the present modelling system may be obtained from a reference including but not limited to a written and/or electronic document.

In one aspect, the independent properties used in the present modelling system may be obtained by measuring said independent properties.

In one aspect, the independent properties used in the present modelling system may be obtained by the use of a commercial or otherwise existing model comprising the steps of:
a.) structure entry into a computer, said structure entry can be achieved via sketching using, for example, the following software such as: Sybyl® (Ver. 6.9, Tripos, Inc, St. Louis, Mo.); Cerius2® (Ver. 4.9, Accelrys, Inc., San Diego, Calif.); ChemFinder™ (Ver. 7.0, CambridgeSoft, Cambridge, Mass.); Spartan '02 (Build 119, Wavefunction, Inc., Irvine, Calif.); CAChe™ (Ver. 5.0, Fujitsu America, Sunnyvale, Calif.); JME Molecular Editor©, or reading pre-stored structures, suitable non-limiting storage formats include SMILES strings; MDL® CTfile or SDF file, Tripos MOL and MOL2 file, PDB file, HyperChem® HIN file, CAChe™ CSF file;
b.) generating 3D atomic coordinates as needed, said generation optionally employing a technique selected from the group consisting of 2D-3D converters, conformational analysis, conformational optimization or combination thereof, and can be achieved using, for example Concord® (Tripos, Inc, St. Louis, Mo.); Corina (Molecular Networks GmbH, Erlangen, Germany); Omega (OpenEye Scientific Software, Santa Fe, N. Mex.); Cerius2® (Ver. 4.9, Accelrys, Inc., San Diego, Calif.); Chem3D™ (Ver. 7.0, CambridgeSoft, Cambridge, Mass.); Spartan '02 (Build 119, Wavefunction, Inc., Irvine, Calif.); CAChe™ (Ver. 5.0, Fujitsu America, Sunnyvale, Calif.), AMPAC™ (Ver. 7.0, Semichem, Shawnee Mission, Kans.), Hyperchem® (Ver. 7.5, Hypercube, Inc., Gainsville, Fla.);
c.) calculating, one or independent properties using said commercial or otherwise existing model.

Suitable commercial models include, but are not limited to: CSLogWS™ (Version 3.0), CSLogD™ (Version 3.0), CSLogWSO™ (Version 3.0) and CSpKa™ (Version 3.0) supplied by ChemSilico™ (ChemSilico LLC, Tewksbury, Mass. 01876); logD (Version 12.0), logP (Version 12.0), pKa (Version 12.0), Aqueous Solubility (Version 12.0) and Boiling Point (Version 12.0) supplied by ACD/Labs (Advanced Chemistry Development, Inc, Toronto, Ontario, Canada M5C 1T4); and ClogP/CMR™ (version 5.0) supplied by BioByte Corp. (Claremont, Calif. 91711-4707).

Suitable existing models include, but are not limited to, Amine-assisted perfume delivery, Western-European washing conditions, 5-weeks post-dry storage model (WE-5); Amine-assisted perfume delivery, North-American washing conditions, 1-week post-dry storage model (NA-1) model; Polymer amine-assisted perfume delivery, Western-European washing conditions, 1-day post-dry storage model (WE-1) model; vapor pressure; boiling point; betaCyclodextrins complex stability constant; malodor reduction value; SDS micelle-water partition coefficient; Henrys Law (air-water partition) coefficient; critical micelle concentration; odor masking; Kovats index; perfume ingredient color/odor stability decision model; shampoo product-air perfume raw material partition coefficient; hair conditioner product-air perfume raw material partition coefficient. Such models are given below:

The following linear regression models are implemented using the general formula:

$$y = {b}_{0} + {\sum }_{i = 1}^{n} {b}_{i} {m}_{i}$$

. . . where y is the property being computed, b₀ is the y-intercept, n is the number of descriptors in the model, mᵢ is the ith descriptor in the model, and bᵢ is the coefficient for the ith descriptor.
1) Amine-assisted perfume delivery, Western-European washing conditions, 5-weeks post dry (WE-5). Output: log(Headspace response ratio). Descriptor source: winMolconn (Hall Associates Consulting, Ver. 1.0.1.3). Structure Preparation: 2D connection table (SDF format or SMILES).

| Descriptor | Coefficient |
|---|---|
| Hmin | −0.5651 |
| e1C2C4 | 0.20566 |
| e2C2O1 | −0.044191 |
| idcbar | −0.745 |
| n2pag13 | 0.102 |
| n3pag24 | −0.13909 |
| n4pag13 | −0.10552 |
| Y-intercept | 2.4994 |

2) Amine-assisted perfume delivery, North-American washing conditions, 1-week post dry (NA-1). Output: log(Headspace response ratio). Descriptor source: winMolconn (Hall Associates Consulting, Ver. 1.0.1.3). Structure Preparation: 2D connection table (SDF format or SMILES).

| Descriptor | Coefficient |
|---|---|
| SsssCH | −0.29598 |
| k0 | 0.035569 |
| phia | −0.07447 |
| e1C3C3d | −0.18811 |
| e2C3O1s | 0.064899 |
| CdO | −0.61952 |
| si | −0.05443 |
| Y-intercept | 0.5594 |

3) Polymeric amine-assisted perfume delivery, Western-European washing conditions, 1-day post dry (WE-1). Output: log(Headspace response ratio). Descriptor source: winMolconn (Hall Associates Consulting, Ver. 1.0.1.3). Structure Preparation: 2D connection table (SDF format or SMILES).

| Descriptor | Coefficient |
|---|---|
| e1C2C2d | 0.31897 |
| n2pag14 | 0.6691 |
| n3pag22 | −0.14115 |
| Y-intercept | 0.6548 |

4) Vapor pressure model. Output: log(Vapor Pressure), mmHg@ 25° C. Descriptor source: winMolconn (Hall Associates Consulting, Ver. 1.0.1.3). Structure Preparation: 2D connection table (SDF format or SMILES).

| Descriptor | Coefficient |
|---|---|
| fw | −0.007781 |
| numHBd | 1.04817 |
| Hmax | 0.24938 |
| sumDelI | 0.13599 |
| SdO | −0.069758 |
| SHother | −0.18671 |
| SHHBd | −1.3593 |
| x1 | −1.30077 |
| dxv1 | −0.54404 |
| e1C1C2 | 0.049572 |
| CHother | 0.34487 |
| y-intercept | 4.54492 |

5) Boiling point model. Output: boiling point, ° C.@ 760 mmHg Descriptor source: winMolconn (Hall Associates Consulting, Ver. 1.0.1.3). Structure Preparation: 2D connection table (SDF format or SMILES).

| Descriptor | Coefficient |
|---|---|
| nasH | −2.2299 |
| Gmax | 5.5242 |
| tets2 | 4.9348 |
| SsOH | −32.524 |
| SEster | −5.6991 |
| x1 | 58.8 |
| e1C2C2d | −3.2115 |
| CHsOH | 311.33 |
| idc | −0.21188 |
| Wp | −1.4682 |
| n3pag12 | 1.8151 |
| y-intercept | −100.459 |

6) SDS Water-Micelle partition coefficient (Sodium dodecylsulfate micelles). Output: log(K Water/SDS) @ 25° C. Descriptor source: winMolconn (Hall Associates Consulting, Ver. 1.0.1.3). Structure Preparation: 2D connection table (SDF format or SMILES).

| Descriptor | Coefficient |
|---|---|
| nvx | −0.11048 |
| EPSA | 0.121025 |
| SdssC | 1.35059 |
| SaasC | −0.07499 |
| SdO | −0.074285 |
| SHCsatu | 0.28403 |
| NHBint2 | 0.31498 |
| xch6 | 3.8245 |
| xv1 | −0.59692 |
| e1C3O1a | −0.086153 |
| y-intercept | −1.75482 |

7) Henry's Law Constant model. Output: log(Henry's Law Constant) @ 25° C. Descriptor source: winMolconn (Hall Associates Consulting, Ver. 1.0.1.3). Structure Preparation: 2D connection table (SDF format or SMILES).

| Descriptor | Coefficient |
|---|---|
| nelem | −1.41162 |
| Qv | 0.36183 |
| SssO | 0.085149 |
| SEster | 0.18763 |
| SHHBd | −0.53816 |
| x1 | −1.19824 |
| dx0 | 1.016 |
| CHother | 0.3241 |
| TM | −0.11456 |
| CSLogP (Ver 3.0) | 0.67686 |
| y-intercept | 2.6723 |

8) Critical Micelle Concentration (Anionic surfactants, sodium counter ion). Output: log(CMC), mol/L @ 40° C. Descriptor source: winMolconn (Hall Associates Consulting, Ver. 1.0.1.3). Structure Preparation: 2D connection table (SDF format or SMILES).

| Descriptor | Coefficient |
|---|---|
| nrbond | −0.056106 |
| TPSA | 0.015483 |
| xv1 | −0.26634 |
| nclass | −0.042869 |
| e1C2C2 | −0.14911 |
| CssCH2 | 0.15171 |
| n3pag34 | −0.19529 |
| y-intercept | 0.75014 |

9) Shampoo product-air perfume raw material partition coefficient. Output: logHLCsh; where HLCsh=[PRM in air]/[PRM in shampoo formulation]. Descriptor source: winMolconn (Hall Associates Consulting, Ver. 1.0.1.3). Structure Preparation: 2D connection table (SDF format or SMILES).

| Descriptor | Coefficient |
|---|---|
| SUMEST | −0.0123319 |
| Gmin | −0.6335 |
| tets2 | −0.06155 |
| Qv | 0.9565 |
| SKetone | −0.072583 |
| dx2 | −0.4641 |
| ka2 | −0.20459 |
| e2C3O1s | 0.04281 |
| Csp3OH | −1.6152 |
| TG3 | 0.13589 |
| n3pag12 | −0.06698 |
| n4pag22 | −0.06483 |
| y-intercept | −1.8516 |

10) Hair-conditioner product-air perfume raw material partition coefficient. Output: logHLChc; where HLChc=[PRM in air]/[PRM in hair-conditioner formulation]. Descriptor source: winMolconn (Hall Associates Consulting, Ver. 1.0.1.3). Structure Preparation: 2D connection table (SDF format or SMILES).

| Descriptor | Coefficient |
|---|---|
| dxp3 | −0.181 |
| dxp7 | −0.729 |
| CHother | −2.256 |
| CsssCH | 0.230 |
| Y-Intercept | −1.96 |

11) beta-Cyclodextrin Complex Stability Constant. Output: logK (log of the ligand/β-CD complex stability constant). Descriptor source: ADAPT (P.C. Jurs, Penn State University). Structure Preparation: 2D to 3D conversion using Concord, structure optimization using Tripos force field including electrostatic terms, Gasteiger-Huckel partial atomic charges).

| Descriptors | Coefficient |
|---|---|
| PNSA-3 | −0.008666 |
| RSAH | 0.018027 |
| RSHM | −5.8579 |
| NSB | 0.061339 |
| NAB | −0.063134 |
| WTPT-2 | 7.305 |
| FPHS-3 | 4.0056 |
| y-intercept | −12.2641 |

12) Malodor reduction value. Output: Malodor Reduction Value (MRV_{MW}, molecular-weight corrected) where MRV_{MW}=MRV (molecular weight of the PRM/88.1051). Descriptor source: ADAPT (P. C. Jurs, Penn State University). Structure Preparation: 2D to 3D conversion using Concord, structure optimization using Tripos force field including electrostatic terms, Gasteiger-Huckel partial atomic charges).

| Descriptor | Coefficient |
|---|---|
| S6C | −7.592 |
| NBR | 1.7288 |
| GEOH-3 | 3.5357 |
| MOMH-7 | 1.7318 |
| y-intercept | −4.2818 |

13) Malodor masking. Output: malodor masking (%). Descriptor source: ADAPT (P. C. Jurs, Penn State University). Structure Preparation: 2D to 3D conversion using Concord, structure optimization using Tripos force field including electrostatic terms, Gasteiger-Huckel partial atomic charges).

| Descriptor | Coefficient |
|---|---|
| MOMH-3 | −0.03987 |
| FNSA-2 | 71.01601 |
| S4PC | −4.3181 |
| MOMH-5 | −0.59165 |
| RHTA | −30.79279 |
| RSHM | 266.67008 |
| y-intercept | 128.4402 |

14) Kovats index. Output: Kovats index (KI) for a DB5 column Descriptor source: ADAPT (P. C. Jurs, Penn State University). Structure Preparation: 2D to 3D conversion using Concord, structure optimization using Tripos force field including electrostatic terms, Gasteiger-Huckel partial atomic charges. Where needed, descriptors use the Gasteiger-Huckel partial atomic charges.

| Descriptor | Coefficient |
|---|---|
| WNHS-3 | −24.846 |
| FPSA-1 | −491.37 |
| PNHS-1 | 5.291 |
| RSAA | 1.2808 |
| DPHS-1 | 3.04187 |
| NRA | 37.527 |
| S6PC | 10.065 |
| y-intercept | 106.45 |

The following models are implemented as decision-trees expressed as a series of rules used to classify structures into particular populations.
15) Perfume ingredient color/odor stability decision model. Output: predicted stability class assignment.

```
C Requires 4 winMolconn descriptors
C  (Hall Associates Consulting, Ver. 1.0.1.3)
C  nd3
C  SHCsatu
C  SHCsats
C  Gmax
C
C Requires also one computed physical property
C  CSLogWS₀ (ChemSilico intrinsic aqueous solubility,
C  version 3.0)
C
C Structure Preparation: 2D connection table
C  (SDF format or SMILES)
C
C Decision Tree generates three possible outcomes
C  Stable
C  Unstable
C  Uncertain
C
C  Begin Decision Tree Logic
C
  If (nd3 >= 3) then
    If (SHCsatu >= 0.736139) then
    Class = Unstable
  Else
    Class = Uncertain
  Else
    If (SHCsats >= 3.03025) then
    Class = Stable
    Else
    If (Gmax >= 8.62977) then
      If (CSlogWS0 >= −1.66) then
        Class = Uncertain
      Else
        Class = Unstable
    Else
      Class = Stable
    Endif
    Endif
  Endif
C
C  End of Decision Tree
C
```

In one aspect, the independent properties used in the present modelling system may be obtained by a first modelling method comprising:
a.) correlating a dependent property of an initial consumer product component, with an independent variable of said component; said step typically comprising:
   (i) structure entry into a computer, said structure entry can be achieved via sketching using, for example, the following software such as: Sybyl® (Ver. 6.9, Tripos, Inc, St. Louis, Mo.); Cerius2® (Ver. 4.9, Accelrys, Inc., San Diego, Calif.); ChemFinder™ (Ver. 7.0, CambridgeSoft, Cambridge, Mass.); Spartan '02 (Build 119, Wavefunction, Inc., Irvine, Calif.); CAChe™ (Ver. 5.0, Fujitsu America, Sunnyvale, Calif.); JME Molecular Editor©, or reading pre-stored structures, suitable non-limiting storage formats include SMILES strings; MDL® CTfile or SDF file, Tripos MOL and MOL2 file, PDB file, HyperChem® HIN file, CAChe™ CSF file;
   (ii) generating 3D atomic coordinates as needed, said generation optionally employing a technique selected from the group consisting of 2D-3D converters, conformational analysis, conformational optimization or combination thereof, and can be achieved using, for example Concord® (Tripos, Inc, St. Louis, Mo.); Corina (Molecular Networks GmbH, Erlangen, Germany); Omega (OpenEye Scientific Software, Santa Fe, N. Mex.); Cerius2® (Ver. 4.9, Accelrys, Inc., San Diego, Calif.); Chem3D™ (Ver. 7.0, CambridgeSoft, Cambridge, Mass.); Spartan '02 (Build 119, Wavefunction, Inc., Irvine, Calif.); CAChe™ (Ver. 5.0, Fujitsu America, Sunnyvale, Calif.), AMPAC™ (Ver. 7.0, Semichem, Shawnee Mission, Kans.), Hyperchem® (Ver. 7.5, Hypercube, Inc., Gainsville, Fla.);
   (iii) calculating said independent variable, said calculation being achieved in one aspect of said method by using, for example, Cerius2® (Ver. 4.9, Accelrys, Inc., San Diego, Calif.); Spartan '02 (Build 119, Wavefunction, Inc., Irvine, Calif.); CAChe™ (Ver. 5.0, Fujitsu America, Sunnyvale, Calif.), Codessa™ (Ver. 2.7.2, Semichem, Shawnee Mission, Kans.); ADAPT (Prof. P. C. Jurs, Penn State University, University Park, Pa.); Dragon (Talete, srl., Milano, Italy); Sybyl® (Ver. 6.9, Tripos, Inc, St. Louis, Mo.), MolconnZ™ (Ver. 4.05, eduSoft, Ashland, Va.), Hyperchem® (Ver. 7.5, Hypercube, Inc., Gainsville, Fla.);
   (iv) performing objective feature analysis as needed, said objective feature analysis typically including removing independent variables exhibiting little or no variance and/or removing independent variables showing high pairwise correlation to other independent variables; said performance can be achieved by employing, for example, ADAPT (Prof. P. C. Jurs, Penn State University, University Park, Pa.); Minitab® (Ver. 14, Minitab, Inc., State College, Pa.); JMP™ (Ver. 5.1, SAS Institute Inc., Cary, N.C.); Mobydigs (Talete, srl., Milano, Italy);
   (v) generating a statistical molecular model that correlates said dependent property with said independent variable—such generation achieved in one aspect of said method by employing, for example, Cerius2® (Ver. 4.9, Accelrys, Inc., San Diego, Calif.); CAChe™ (Ver. 5.0, Fujitsu America, Sunnyvale, Calif.), Codessa™ (Ver. 2.7.2, Semichem, Shawnee Mission, Kans.); ADAPT (Prof. P. C. Jurs, Penn State University, University Park, Pa.); Sybyl® (Ver. 6.9, Tripos, Inc, St. Louis, Mo.); Minitab® (Ver. 14, Minitab, Inc., State College, Pa.); JMP™ (Ver. 5.1, SAS Institute Inc., Cary, N.C.); Mobydigs (Talete, srl., Milano, Italy); Simca-P (Umetrics, Inc. Kinnelon, N.J.); R Statistical Language (The R Foundation for Statistical Computing); S-Plus® (Insightful®, Seattle, Wash.);
b.) calculating said dependent property for an additional consumer product component by inputting said independent variable of said additional consumer product component into the correlation of Step a.); and/or defining the relationship between changes in said initial component's molecular structure and said initial component's dependent property by analysing the correlation of Step a.);
c.) optionally, using the output of Step b.) to refine the correlation of Step a.); and
d.) optionally repeating Steps a.) through c.).

In said first aspect of said modelling method, said correlation may be achieved by employing a technique selected from the group consisting of multiple linear regression, genetic function method, generalized simulated annealing, principal components regression, non-linear regression, projection to latent structures regression, neural networks, support vector machines, logistic regression, ridge regression, cluster analysis, discriminant analysis, decision trees, nearest-neighbor classifier, molecular similarity analysis, molecular diversity analysis, comparative molecular field analysis, Free and Wilson analysis, and combinations thereof; a technique selected from the group consisting of multiple linear regression, genetic function method, generalized simulated annealing, principal components regression, non-linear regression, projection to latent structures regression, neural networks, support vector machines, logistic regression, ridge regression, cluster analysis, discriminant analysis, molecular similarity analysis, molecular diversity analysis, and combinations thereof; or even more simply a technique selected from the group consisting of multiple linear regression, genetic function method, generalized simulated annealing, projection to latent structures regression, neural networks, cluster analysis, discriminant analysis, molecular similarity analysis, molecular diversity analysis, and combinations thereof.

In said first aspect of said modelling method, said initial consumer product component may be selected from the group consisting of surfactants, chelating agents, dye transfer inhibiting agents, dispersants, and enzyme stabilizers, catalysts, bleach activators, sources of hydrogen peroxide, preformed peracids, brighteners, dyes, perfumes, carriers, hydrotropes, solvents and combinations thereof. In one aspect, of the modelling method said initial consumer product component is not a polymer having a solubility of at least 10 ppm at 20° C., a weight average molecular weight from about 1500 to 200,000 daltons comprising a main chain and at least one side chain extending from the main chain; the side chain comprising an alkoxy moiety and the side chain comprising a terminal end such that the terminal end terminates the side chain. In one or more aspects of the modelling method said initial consumer product component is a non-polymer component. In one or more aspects of the modelling method said initial consumer product component is a biological material such as a protein and/or sugar based component, such as cellulose.

In said first aspect of said modelling method, said dependent property may be selected from the group consisting of component: concentration; partition coefficient; vapor pressure; solubility; permeability; permeation rate; chemical reaction, including but not limited to atmospheric degradation and/or transformation, hydrolysis, and photolysis; color; color intensity; color bandwidth; CIE Lab color definition; solubility parameters; particle size; light transmission; light absorption; coefficient of friction; color change; viscosity; phase stability; pH; ultraviolet spectrum; visible light spectrum; infrared spectrum; vibrational frequency; Raman spectrum; circular dichroism; nuclear magnetic resonance spectrum; mass spectrum; boiling point; melting point; freezing point; chromatographic retention index; refractive index; surface tension; surface coverage; critical micelle concentration; odor detection threshold; odor character; human odor-emotive response; protein binding; bacterial minimum inhibition concentration; enzyme inhibition concentration; enzyme reaction rate; host-guest complex stability constant; receptor binding; receptor activity; ion-channel activity; ion concentration; molecular structure similarity; mutagenicity; carcinogenicity; acute toxicity; chronic toxicity; skin sensitization; irritations, including but not limited to eye, oral, nasal and skin irritations; absorption; distribution; metabolism; excretion; Type I allergy; bioconcentration; biodegradation, including but not limited to, biodegradation metabolite maps; bioaccumulation; Henrys Law constants; and combinations thereof.

In said first aspect of said modelling method, said dependent property may be selected from the group consisting of component: concentration; partition coefficient; vapor pressure; solubility; permeability; permeation rate; chemical reaction, including but not limited to atmospheric degradation and/or transformation, hydrolysis, and photolysis; color; color intensity; color bandwidth; CIE Lab color definition; solubility parameters; particle size; light transmission; light absorption; coefficient of friction; color change; viscosity; phase stability; pH; ultraviolet spectrum; visible light spectrum; infrared spectrum; vibrational frequency; Raman spectrum; circular dichroism; nuclear magnetic resonance spectrum; mass spectrum; boiling point; melting point; freezing point; chromatographic retention index; refractive index; surface tension; surface coverage; critical micelle concentration; odor detection threshold; odor character; human odor-emotive response; protein binding; bacterial minimum inhibition concentration; enzyme inhibition concentration; enzyme reaction rate; host-guest complex stability constant; receptor binding; receptor activity; ion-channel activity; ion concentration; molecular structure similarity; mutagenicity; carcinogenicity; acute toxicity; chronic toxicity; skin sensitization; irritations, including but not limited to eye, oral, nasal and skin irritations; absorption; distribution; metabolism; excretion; Type I allergy; bioconcentration, biodegradation, bioaccumulation, including biodegradation metabolite maps; Henrys Law constants; and combinations thereof; said dependent property may be selected from the group consisting of component: concentration, partition coefficient, vapor pressure, solubility, permeability, permeation rate, chemical reaction, color, color intensity, color bandwidth, CIE Lab color definition, solubility parameters, particle size, light transmission, light absorption, coefficient of friction, color change, viscosity, phase stability, pH, boiling point, melting point, freezing point, chromatographic retention index, refractive index, surface tension, critical micelle concentration, odor detection threshold, odor character, human odor-emotive response, bacterial minimum inhibition concentration, enzyme inhibition concentration, enzyme reaction rate, host-guest complex stability constant, molecular structure similarity, mutagenicity, carcinogenicity, acute toxicity, chronic toxicity, skin sensitization, and combinations thereof; or even more simply said dependent property may be selected from the group consisting of component: concentration, partition coefficient, vapor pressure, solubility, permeability, permeation rate, chemical reaction, color, color intensity, color bandwidth, CIE Lab color definition, solubility parameters, light transmission, light absorption, coefficient of friction, color change, viscosity, phase stability, pH, boiling point, melting point, freezing point, chromatographic retention index, refractive index, surface tension, critical micelle concentration, odor detection threshold, odor character, bacterial minimum inhibition concentration, host-guest complex stability constant, molecular structure similarity, and combinations thereof.

In said first aspect of said modelling method, said independent variable may be selected from the group consisting of constitutional descriptors, Hammett parameters, substituent constants, molecular holograms, substructure descriptors, BC(DEF) parameters, molar refractivity, molecular polarizability, topological atom pairs descriptors, topological torsion descriptors, atomic information content, molecular connectivity indices, electrotopological-state indices, path counts, Kier molecular shape descriptors, distance connectivity indices, Wiener index, centric indices, flexibility descriptors, molecular identification numbers, information connectivity indices, bond information index, molecular complexity indices, resonance indices, van der Waals surface area and volume, solvent-accessible surface area and volume, major moments of inertia, molecular length, width, and thickness, shadow areas, through-space distance between atoms and molecular fragments, radius of gyration, 3D-Weiner index, volume overlaps, sterimol parameters, geometric atom pairs descriptors, chirality descriptors, cis/trans descriptors, dipole and higher moments, resonance indices, hydrogen-bonding descriptors, partial atomic charges, HOMO energy level, LUMO energy level, electrostatic potential, quantum-chemical hardness and softness indices, superdelocalizability indices, ionization potential, molecular fields, excited state energies, polarizability, hyperpolarizability, charged partial surface area descriptors, hydrophobic surface area descriptors, Burden eigenvalues, BCUT descriptors, molecular docking scores, binding constants, octanol-water partition coefficient, cyclohexane-water partition coefficient, normal boiling point, chromatographic retention indices, nuclear magnetic resonance spectra, infrared spectra, ultraviolet spectra, color (visible wavelength) spectra, pKa, aqueous solubility, Hansen solubility parameters, Hoy solubility parameters, heat of formation, heat of vaporization, protein-ligand binding, protein receptor activation, protein receptor inhibition, enzyme inhibition, skin permeability, hydrophobic-hydrophilic balance, and combinations thereof; said independent variable may be selected from the group consisting of constitutional descriptors, substituent constants, molecular holograms, substructure descriptors, molar refractivity, molecular polarizability, molecular connectivity indices, electrotopological-state indices, path counts, Kier molecular shape descriptors, distance connectivity indices, Wiener index, centric indices, flexibility descriptors, molecular identification numbers, bond information index, molecular complexity indices, van der Waals surface area and volume, solvent-accessible surface area and volume, major moments of inertia, molecular length, width, and thickness, radius of gyration, volume overlaps, chirality descriptors, cis/trans descriptors, dipole moments, resonance indices, hydrogen-bonding descriptors, partial atomic charges, HOMO energy level, LUMO energy level, electrostatic potential, quantum-chemical hardness and softness indices, superdelocalizability indices, ionization potential, charged partial surface area descriptors, hydrophobic surface area descriptors, binding constants, octanol-water partition coefficient, pKa, aqueous solubility, Hansen solubility parameters, hydrophobic-hydrophilic balance, and combinations thereof; or even more simply said independent variable may be selected from the group consisting of constitutional descriptors, substituent constants, substructure descriptors, molar refractivity, molecular polarizability, molecular connectivity indices, electrotopological-state indices, path counts, Kier molecular shape descriptors, distance connectivity indices, Wiener index, flexibility descriptors, molecular identification numbers, molecular complexity indices, van der Waals surface area and volume, solvent-accessible surface area and volume, major moments of inertia, molecular length, width, and thickness, radius of gyration, dipole moments, hydrogen-bonding descriptors, partial atomic charges, HOMO energy level, LUMO energy level, electrostatic potential, quantum-chemical hardness and softness indices, superdelocalizability indices, charged partial surface area descriptors, hydrophobic surface area descriptors, octanol-water partition coefficient, pKa, aqueous solubility, and combinations thereof. In one or more aspects of the aforementioned model, COSMO-RS descriptors are not employed as an independent variable.

In said first aspect of said modelling method, said dependent property may be selected from the group consisting of component: concentration, partition coefficient, vapor pressure, solubility, permeability, permeation rate, reaction rate, color, color intensity, solubility parameters, particle size, light transmission, light absorption, coefficient of friction, color change, viscosity, phase stability, pH, ultraviolet spectrum, visible light spectrum, infrared spectrum, nuclear magnetic resonance spectrum, mass spectrum, boiling point, melting point, freezing point, chromatographic retention index, refractive index, surface tension, surface coverage, critical micelle concentration, odor detection threshold, odor character, human odor-emotive response, protein binding, bacterial minimum inhibition concentration, enzyme inhibition concentration, enzyme reaction rate, host-guest complex stability constant, receptor binding, receptor activity, ion-channel activity, ion concentration, molecular structure similarity, mutagenicity, carcinogenicity, acute toxicity, chronic toxicity, skin sensitization, rate of metabolism, rate of excretion, and combinations thereof; and said independent variable may be selected from the group consisting of constitutional descriptors, Hammett parameters, substituent constants, molecular holograms, substructure descriptors, BC(DEF) parameters, molar refractivity, molecular polarizability, topological atom pairs descriptors, topological torsion descriptors, atomic information content, molecular connectivity indices, electrotopological-state indices, path counts, Kier molecular shape descriptors, distance connectivity indices, Wiener index, centric indices, flexibility descriptors, molecular identification numbers, information connectivity indices, bond information index, molecular complexity indices, resonance indices, van der Waals surface area and volume, solvent-accessible surface area and volume, major moments of inertia, molecular length, width, and thickness, shadow areas, through-space distance between atoms and molecular fragments, radius of gyration, 3D-Weiner index, volume overlaps, sterimol parameters, geometric atom pairs descriptors, chirality descriptors, cis/trans descriptors, dipole moments, resonance indices, hydrogen-bonding descriptors, partial atomic charges, HOMO energy level, LUMO energy level, electrostatic potential, quantum-chemical hardness and softness indices, superdelocalizability indices, ionization potential, molecular fields, charged partial surface area descriptors, hydrophobic surface area descriptors, Burden eigenvalues, BCUT descriptors, molecular docking scores, binding constants, octanol-water partition coefficient, cyclohexane-water partition coefficient, normal boiling point, chromatographic retention indices, nuclear magnetic resonance spectra, infrared spectra, ultraviolet spectra, color (visible wavelength) spectra, pKa, aqueous solubility, Hansen solubility parameters, heat of formation, heat of vaporization, protein binding, skin permeability, hydrophobic-hydrophilic balance, and combinations thereof.

In said first aspect of said modelling method, said dependent property may be selected from the group consisting of component: concentration, partition coefficient, vapor pressure, solubility, permeability, permeation rate, reaction rate, color, color intensity, solubility parameters, light transmission, light absorption, coefficient of friction, color change, viscosity, phase stability, pH, boiling point, melting point, freezing point, chromatographic retention index, refractive index, surface tension, critical micelle concentration, odor character, bacterial minimum inhibition concentration, host-guest complex stability constant, molecular structure similarity, and combinations thereof; said independent variable may be selected from the group consisting of constitutional descriptors, substituent constants, substructure descriptors, molar refractivity, molecular polarizability, molecular connectivity indices, electrotopological-state indices, path counts, Kier molecular shape descriptors, distance connectivity indices, Wiener index, flexibility descriptors, molecular identification numbers, molecular complexity indices, van der Waals surface area and volume, solvent-accessible surface area and volume, major moments of inertia, molecular length, width, and thickness, radius of gyration, dipole moments, hydrogen-bonding descriptors, partial atomic charges, HOMO energy level, LUMO energy level, electrostatic potential, quantum-chemical hardness and softness indices, superdelocalizability indices, charged partial surface area descriptors, hydrophobic surface area descriptors, octanol-water partition coefficient, pKa, aqueous solubility, and combinations thereof; and said correlation may be achieved by employing a technique selected from the group consisting of multiple linear regression, projection to latent structures regression, neural networks, cluster analysis, discriminant analysis, molecular similarity analysis, molecular diversity analysis, and combinations thereof.

In any of the foregoing aspects of the invention said dependent property may be single dependent property, the output of Step b.) may be used to refine the correlation of Step a.); Steps a.) through c.) may be repeated at least once; the output of Step b.) may be used to refine the correlation of Step a.) or combination thereof.

In any of the foregoing aspects of the invention, when the consumer product component is a polymer, modelling may be conducted as previously described except the correlation Step a.) is achieved using a technique other than multiple linear regression, or the correlation technique does not employ molecular fragmentation.

### Method of Facilitating a Collaboration

A process of high through put virtual screening while maintaining confidentiality that may comprise a provider providing a device comprising decision software to a receiving party, said device and/or software structured such that said provider cannot access said receiving party's inputs into said device and/or software; and said receiving party cannot interpret the decisions, based on such receiving party's inputs, that are made by such decision software, said decisions being coded such that said provider can decode said decisions but not said receiving party's inputs is disclosed.

In one aspect of the process disclosed above, said receiver may disclose selected input to said provider.

In one aspect of the process disclosed above, said software may comprise a modelling method and said receiver provides input into said software.

In one aspect of the process disclosed above, said device may comprise a portable computing device.

### Consumer Products

As taught by the present specification, including the examples included herein, the modeling systems disclosed herein may be used to design consumer products and selected components for use in consumer products as such products are defined in the present specification.

### Adjunct Materials for Consumer Products

While not essential for the purposes of the present invention, the non-limiting list of adjuncts illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. It is understood that such adjuncts are in addition to the dye conjugate and optional stripping agent components of Applicants' compositions. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, structurants, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

As stated, the adjunct ingredients are not essential to Applicants' compositions. Thus, certain embodiments of Applicants' compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. However, when one or more adjuncts are present, such one or more adjuncts may be present as detailed below:

Bleaching Agents—Bleaching agents other than bleaching catalysts include photobleaches, bleach activators, hydrogen peroxide, sources of hydrogen peroxide, preformed peracids. Examples of suitable bleaching agents include anhydrous sodium perborate (mono or tetrahydrate), anhydrous sodium percarbonate, tetraacetyl ethylene diamine, nonanoyloxybenzene sulfonate, sulfonated zinc phtalocyanine and mixtures thereof.

When a bleaching agent is used, the compositions of the present invention may comprise from about 0.1% to about 50% or even from about 0.1% to about 25% bleaching agent by weight of the subject cleaning composition.

Surfactants—The compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof.

The surfactant is typically present at a level of from about 0.1% to about 60%, from about 1% to about 50% or even from about 5% to about 40% by weight of the subject composition.

Builders—The compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds. ether hydroxypolycarboxylates, copolymers of maleic anhydride with ethylene or vinyl methyl ether, 1, 3, 5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The compositions herein may contain a chelating agent. Suitable chelating agents include copper, iron and/or manganese chelating agents and mixtures thereof.

When a chelating agent is used, the composition may comprise from about 0.1% to about 15% or even from about 3.0% to about 10% chelating agent by weight of the subject composition.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in a subject composition, the dye transfer inhibiting agents may be present at levels from about 0.0001% to about 10%, from about 0.01% to about 5% or even from about 0.1% to about 3% by weight of the composition.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—The compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that comprises a protease, lipase, cutinase and/or cellulase in conjunction with amylase.

When present in a cleaning composition, the aforementioned adjunct enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor can be added to further improve stability.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminium cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of a macropolycyclic rigid ligand—abbreviated as “MRL”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRL's include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

Processes of Making Cleaning and/or Treatment Compositions

The cleaning compositions of the present invention can be formulated into any suitable form and prepared by any process chosen by the formulator, non-limiting examples of which are described in Applicants examples and in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Method of Use

The consumer products of the present invention may be used in any conventional manner In short, they may be used in the same manner as consumer products that are designed and produced by conventional methods and processes. For example, cleaning and/or treatment compositions of the present invention can be used to clean and/or treat a situs inter alia a surface or fabric. Typically at least a portion of the situs is contacted with an embodiment of Applicants' composition, in neat form or diluted in a wash liquor, and then the situs is optionally washed and/or rinsed. For purposes of the present invention, washing includes but is not limited to, scrubbing, and mechanical agitation. The fabric may comprise any fabric capable of being laundered in normal consumer use conditions. Cleaning solutions that comprise the disclosed cleaning compositions typically have a pH of from about 5 to about 10.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric mass ratio is typically from about 1:1 to about 100:1.

### Test Methods for Examples 1-7

### Western-European Washing Conditions, 5-Weeks Post-Dry Storage Model (WE-5) Test for Determining Observed Headspace Response Ratio (HRR) Values for Amine-Assisted Perfume Delivery (AAPD) Formulations

Two sets of fabric samples consisting of 32 terry tracers (40×40 cm) each are preconditioned by washing 4 times: 2 times with 70 g Ariel Sensitive (commercial powder detergent nil perfume product from the Procter & Gamble Company) and 2 times without powder at 90° C. One set is designated as a control (nil technology) set and is prepared by washing using a conventional HDL formulation comprising cleaning agents (anionic and nonionic surfactants), solvents, water, stabilizing agents, enzymes, and colorants. The formulation is also spiked with 1% perfume. The second set is prepared by washing using the same HDL formulation containing 1% perfume and Lupasol® WF or HF (polyethyleneamine with a molecular weight of 25000) supplied by BASF. The fabric samples are washed using Miele Novotronic type W715 washing machines using a short cycle (75 minutes) at 40° C., city water (2.5 mM), no fabric softener added. After the wash the tracers are line dried. When dry, tracers are wrapped in aluminium foil and stored for 5-weeks before analysis using headspace GC/MS analysis.

Headspace GC/MS analysis is carried out by placing about 40 g of fabric in a 1 L closed headspace vessel that is then stored at ambient conditions overnight. After storage, sampling of the headspace is accomplished by drawing a 3 L sample, over 2 hours with a helium flow rate of 25 ml/min, onto the Tenax-TA trap at ambient conditions. The trap is then dry-purged using a reverse-direction helium flow at a rate of 25 ml/min for 30 minutes. In order to desorb trapped compounds, the trap is then heated at 180° C. for 10 minutes directly into the injection-port of a GC/MS. The separation conditions for the GC are a Durawax-4 (60 m, 0.32 mm ID, 0.25 μm Film) column with a temperature program starting at 40° C. and heating to 230° C. at a rate of 4° C./min, holding at 230° C. for 20 minutes. Eluted components are detected using spectrometric detection, and the response is taken as the area of the peak for each perfume component. The results are expressed as the ratio of the areas for a given perfume material of the technology versus nil-technology samples.

### North-American Washing Conditions, 1-Week Post-Dry Storage Model (NA-1) Model: Test for Determining Observed Headspace Response Ratio (HRR) Values for Amine-Assisted Perfume Delivery (AAPD) Formulations

Two sets of fabric samples consisting of 32 terry tracers (40×40 cm) each are preconditioned by washing 4 times: 2 times with 70 g Ariel Sensitive (powder nil perfume) and 2 times without powder at 90° C. One set of tracers is designated as a control set (nil technology) and is prepared by washing using an HDL formulation comprising cleaning agents (anionic and nonionic surfactants), solvents, water, stabilizing agents, enzymes, and colorants. The formulation is also spiked with 1% perfume. The second set of tracers is prepared by washing using the same HDL formulation containing 1% perfume and N,N′-Bis-(3-aminopropyl)-ethylenediamine. The fabric samples are washed using Kenmore 80 Series Heavy Duty washing machines using a heavy-duty cycle for 12 minutes at 32° C., 1 mM water, and are then rinsed once at 20° C. using a heavy duty cycle. After the wash the tracers are tumble dried. When dry, tracers are wrapped in aluminium foil and stored for 1-week before analysis using headspace GC/MS analysis. Headspace GC/MS analysis is carried out according to the procedure listed in Western-European washing conditions, 5-weeks post-dry storage model (WE-5) detailed above.

Polymer Amine-Assisted Perfume Delivery, Western-European Washing Conditions, 1-Day Post-Dry Storage Model (WE-1) Model: Test for Determining Observed Headspace Response Ratio (HRR) Values for Polymer Amine-Assisted Perfume Delivery (PAAPD) Formulations

Two sets of fabric samples consisting of 32 terry tracers (40×40 cm) each are preconditioned by washing 4 times: 2 times with 70 g Aria Sensitive (powder nil perfume) and 2 times without powder at 90° C. One set is designated as a standard (nil technology) set and is prepared by washing using a standard dry-powder formulation containing 1% perfume only. The second set is prepared by washing using a dry-powder formulation containing 1% perfume and Lupasol WF or HF (polyethyleneamine with a molecular weight of 25000). The fabric samples are washed using Miele Novotronic type W715 washing machines using a short cycle (1 h15 min) at 40° C., city water (2.5 mM), no fabric softener added. After the wash the tracers are line dried. When dry, tracers are wrapped in aluminium foil and stored for 1-day before analysis using headspace GC/MS analysis. Headspace GC/MS analysis is carried out according to the procedure listed in Western-European washing conditions, 5-weeks post-dry storage model (WE-5) detailed above.

### EXAMPLES

### Property-Space Similarity (PSS) Patent Application Examples

### Example 1

### Amine-Assisted Perfume Delivery (AAPD)

The structures of perfume raw materials (PRMs) are entered into a ChemFinder database by sketching or by importing the structures from a compatible file format representing PRMs of interest. The structures are exported from ChemFinder as a text file using the MACCS SDF format or as a SMILES string list. Molecular descriptors are then computed using the winMolconn program. The winMolconn descriptors are used to compute the property predictions for the following properties: PRM headspace response ratio for Western-European washing conditions and 5-weeks storage after drying (WE-5); PRM headspace response ratio for North-American washing conditions and 1-week storage after drying (NA-1); predicted vapor pressure at 25° C. in units of mmHg; and predicted log octanol-water partition coefficients (logP). The predicted properties for all structures are autoscaled (i.e. mean-centered and variance normalized). Delta-damascone is selected as the target (query) PRM, having exhibited good performance in an experimental evaluation of headspace concentrations after washing and drying fabric samples. The predicted properties of each of the PRMs of interest (called test structures) are compared to the query using a Euclidean distance measure computed using the following equation: Distance=((logHRR-WE_{Q}−logHRR-WE_{T})²+(logHRR-NA_{Q}−logHRR-NA_{T})²+(logVP_{Q}−logVP_{T})²+(logP_{Q}−logP_{T})²)^{0.5}

where: logHRR-WE_{Q} and logHRR-WE_{T} are the computed logarithm of the headspace response ratio for the PRM over dry fabric for the query and test structures based on the WE-5 model, respectively. logHRR-NA_{Q} and logHRR-NA_{T} are the computed logarithm of the headspace response ratio for the PRM over dry fabric for the query and test structures based on the NA-1 model, respectively. logVP_{Q} and logVP_{T} are the computed logarithm of the vapor pressure at 25° C. in units of mmHg for the query and test structures, respectively. logP_{Q} and logP_{T} are the computed logarithm of the octanol-water partition coefficient for the query and test structures, respectively. The test PRMs are sorted in order of increasing distance and those with the smallest distance values are selected for experimental evaluation. The comparison is applied and predicts that the following PRMs exhibit dry-fabric odor benefits using amine-assisted perfume delivery: (Z)-1-(2,2-dimethyl-6-methylenecyclohexyl)but-2-en-1-one; (Z)-1-(2,6,6-trimethylcyclohex-2-enyl)but-2-en-1-one; ethyl 6,6-dimethyl-2-methylenecyclohex-3-enecarboxylate; (Z)-hexyl 2-methylbut-2-enoate; 1,3,3-trimethylbicyclo [2.2.1]heptan-2-yl acetate; hexyl pivalate; 2-cyclohexylhepta-1,6-dien-3-one; (E)-1-(2,6,6-trimethylcyclohex-2-enyl)pent-1-en-3-one; phenethyl 2-methylbutanoate; ethyl 2,6,6-trimethylcyclohexa-2,4-dienecarboxylate; (E)-4-(2,6,6-trimethylcyclohex-2-enyl)but-3-en-2-one; (Z)-1-(2,6,6-trimethylcyclohex-1-enyl)but-2-en-1-one; (Z)-1-(2,6,6-trimethylcyclohex-1-enyl)pent-1-en-3-one; 2,2,5-trimethyl-5-pentylcyclopentanone; (Z)-2,6-dimethylocta-2,5,7-trien-4-one.

### Example 2

A software program that implements five separate models Amine-assisted perfume delivery, Western-European washing conditions, 5-weeks post-dry storage model (WE-5); Amine-assisted perfume delivery, North-American washing conditions, 1-week post-dry storage model (NA-1) model; Polymer amine-assisted perfume delivery, Western-European washing conditions, 1-day post-dry storage model (WE-1) model; vapor pressure; and LogP. The program does not identify the identities of the properties being computed. The program requires both hardware and software license keys in order to run such that it cannot be run on the computer provided to the receiving party without the hardware key, and the program cannot be copied to another computer and run using the hardware key alone. The program is encrypted on disk so that it cannot be read directly. The receiving party provides a input file of molecular structures in the form of an MDL® structure-data file (SDF file), or as simplified molecular input line entry specification (SMILES) strings that include the structure information and a structure identifier for each structure that does not disclose the real identity of the structure. The program is executed using this file as input. The receiving party's structure file is deleted, and separate utility programs that are also provided on the computer are used to remove all traces of the structure file from the computer. The program reports the properties computed for the structures in the form of a ASCII text file where the property values are not identified and are scaled so that the original magnitude and sign cannot be discerned without the use of a separate decryption program that is not provided on the computer made available to the receiving party. The results file is decrypted in the providers facility regenerating the desired property identities and values.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process of high through put virtual screening while maintaining confidentiality comprising a provider providing a device comprising decision software to a receiving party, said device and/or software structured such that said provider cannot access said receiving party's inputs into said device and/or software; and said receiving party cannot interpret the decisions, based on such receiving party's inputs, that are made by such decision software, said decisions being coded such that said provider can decode said decisions but not said receiving party's inputs.

2. The process of claim 1 wherein said receiver discloses selected input to said provider.

3. The process of claim 1, wherein said software comprises a modelling method and said receiver provides input into said software.

4. The process of claim 1, wherein said device comprises a portable computing device.
